(19) United States
(12) Patent Application Publication
(10) Pub. No.: US 2007/0061554 A1
(43) Pub. Date: Mar. 15, 2007

(54) Branch predictor for a processor and method of predicting a conditional branch

(75) Inventor: Frank Worrell, San Jose, CA (US)

Correspondence Address: LSI LOGIC CORPORATION, 1621 BARBER LANE, MS: D-106, MILPITAS, CA, 95035, US

(73) Assignee: LSI Logic Corporation, Milpitas, CA (US)

(21) Appl. No.: 11/222,533

(22) Filed: Sep. 9, 2005

(51) Int. Cl. G06F 9/00

(52) U.S. Cl. 712/239

(57) ABSTRACT

A branch predictor, a method of predicting a conditional branch and a digital signal processor incorporating the conditional branch predictor or the method. In one embodiment, the branch predictor includes: (1) static branch correction logic configured to employ a static branch prediction and a correction indicator associated with a particular conditional branch in a computer program to generate a corrected branch prediction pertaining to the particular conditional branch and (2) confidence state updating logic associated with the static branch correction logic and configured to employ the static branch prediction and a branch taken indicator associated with the particular conditional branch to update a confidence state associated with the particular conditional branch, the correction indicator based on the confidence state.

### TECHNICAL FIELD OF THE PRESENT INVENTION

The present invention is directed, in general, to branch prediction, and, more specifically, to a branch predictor for a processor in which static branch predictions are improved and a method of predicting a conditional branch involving the correction of static branch predictions.

### BACKGROUND OF THE PRESENT INVENTION

Digital signal processors (DSPS) play ever-increasing roles in a wide variety of electronic devices, including cellular telephones and video receivers. These devices generally process digital streams of audio and video data of relatively high quality. Thus, their DSPs must be able to handle quantities of data arriving at high rates without introducing significant latency.

DSPs, like many modern processors, use instruction pipelining to increase the throughput of instruction execution. A pipeline is analogous to an assembly line, in which the instruction is processed in stages, each stage completing in one clock cycle. Because an instruction takes multiple clock cycles to complete execution, rather than waiting until that instruction is complete, throughput is increased by beginning processing of the next instruction in the sequence before the first instruction completes processing. Thus for a pipeline with a depth of N stages, as many as N instructions may be simultaneously executing at various stages of completion.

As long as instructions are processed in sequential order, a pipeline processes instructions in a highly efficient manner. However, when a branch instruction in the instruction sequence is encountered, significant inefficiency may result. The instruction sequence after the branch instruction may follow a sequential path or a branch path, depending on the result of a branching condition. The branch condition is typically not resolved until the execution stage of the pipeline. Rather than wait until the branch condition is resolved, a processor typically follows the sequential path at least until the branch condition is resolved. If the branch condition resolves in favor of the sequential path, then no additional action need be taken. However, if the condition resolves in favor of the branch path, then the pipelined instructions following the branch instruction must be flushed from the pipeline, and the processor restored to its state at the point of the branch instruction. Instruction execution then resumes along the branch path. This recovery results in loss of precious time.

To increase the probability that the chosen path is the correct one, processors may employ a scheme to predict the outcome of the branch. One method of prediction is static prediction, in which the outcome of a branch instruction is predicted by the programmer or compiler, for example, and does not change in the course of program execution. Another method of prediction is dynamic prediction, in which the predicted outcome of a branch instruction may change during program execution. For example, a history of actual outcomes at a particular instruction may be used to generate the prediction of the next outcome of the branch at that instruction. Finally, a hybrid method may be used, which combines the attributes of the static and dynamic methods. For example, a static table may be provided to a processor at the beginning of program execution, but the table may be updated during program execution as program history determines that a different outcome is more probable than that stored in the static table.

Various hybrid branch prediction methods are known in the art. One technique uses a history of branch predictions corresponding to a branch address to predict the outcome of a future branch at that instruction address. To save space in a history table, a number of lower order bits of the instruction address may be used to address the history table. This may result in aliasing of the history of different branch instructions with identical lower order bits. Thus, the designer must compromise reduction of size of the history table with an increasing likelihood of aliasing. A method of hybrid branch prediction that reduces the impact of aliasing would allow the designer to reduce the size of the history table below that which might otherwise be practical, reducing chip size and cost.

Therefore, what is needed is a hybrid branch prediction method that is relatively insensitive to aliasing effects, thereby allowing a smaller branch history table.

### SUMMARY OF THE PRESENT INVENTION

To address the above-discussed deficiencies of the prior art, the present invention provides, in one aspect, a branch predictor. In one embodiment, the branch predictor includes: (1) static branch correction logic configured to employ a static branch prediction and a correction indicator associated with a particular conditional branch in a computer program to generate a corrected branch prediction pertaining to the particular conditional branch and (2) confidence state updating logic associated with the static branch correction logic and configured to employ the static branch prediction and a branch taken indicator associated with the particular conditional branch to update a confidence state associated with the particular conditional branch, the correction indicator based on the confidence state.

In another aspect, the present invention provides a method of predicting a conditional branch. In one embodiment, the method includes: (1) employing a static branch prediction and a correction indicator associated with a particular conditional branch in a computer program to generate a corrected branch prediction pertaining to the particular conditional branch and (2) employing the static branch prediction and a branch taken indicator associated with the particular conditional branch to update a confidence state associated with the particular conditional branch, the correction indicator based on the confidence state.

In yet another aspect, the present invention provides a DSP. In one aspect, the DSP includes: (1) a pipeline having stages and configured to execute a computer program containing conditional branches, (2) static branch correction logic configured to employ a static branch prediction and a correction indicator associated with a particular conditional branch in the computer program to generate a corrected branch prediction pertaining to the particular conditional branch, (3) confidence state updating logic associated with the static branch correction logic and configured to employ the static branch prediction and a branch taken indicator associated with the particular conditional branch to update a confidence state associated with the particular conditional branch, the correction indicator based on the confidence state and (4) registers associated with corresponding ones of the pipeline stages configured to shift the confidence state therethrough as the particular conditional branch travels through the corresponding pipeline stages.

The foregoing has outlined preferred and alternative features of the present invention so that those skilled in the art may better understand the detailed description of the present invention that follows. Additional features of the present invention will be described hereinafter that form the subject of the claims of the present invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the present invention.

### BRIEF DESCRIPTION OF THE DRAWINGS

For a more complete understanding of the present invention, reference is now made to the following descriptions taken in conjunction with the accompanying drawing, in which:

FIG. 1 illustrates a block diagram of an exemplary digital signal processor designed according to the principles of the present invention;

FIG. 2 illustrates the ordering of functional blocks in an instruction execution pipeline of the digital signal processor of FIG. 1;

FIG. 3 illustrates a block diagram of a branch predictor designed according to the principles of the present invention;

FIG. 4 shows a state diagram of a state machine operating to adjust a static prediction confidence state according the principles of the present invention; and

FIG. 5 illustrates a block diagram of one embodiment of a branch predictor designed according to the principles of the present invention.

### DETAILED DESCRIPTION

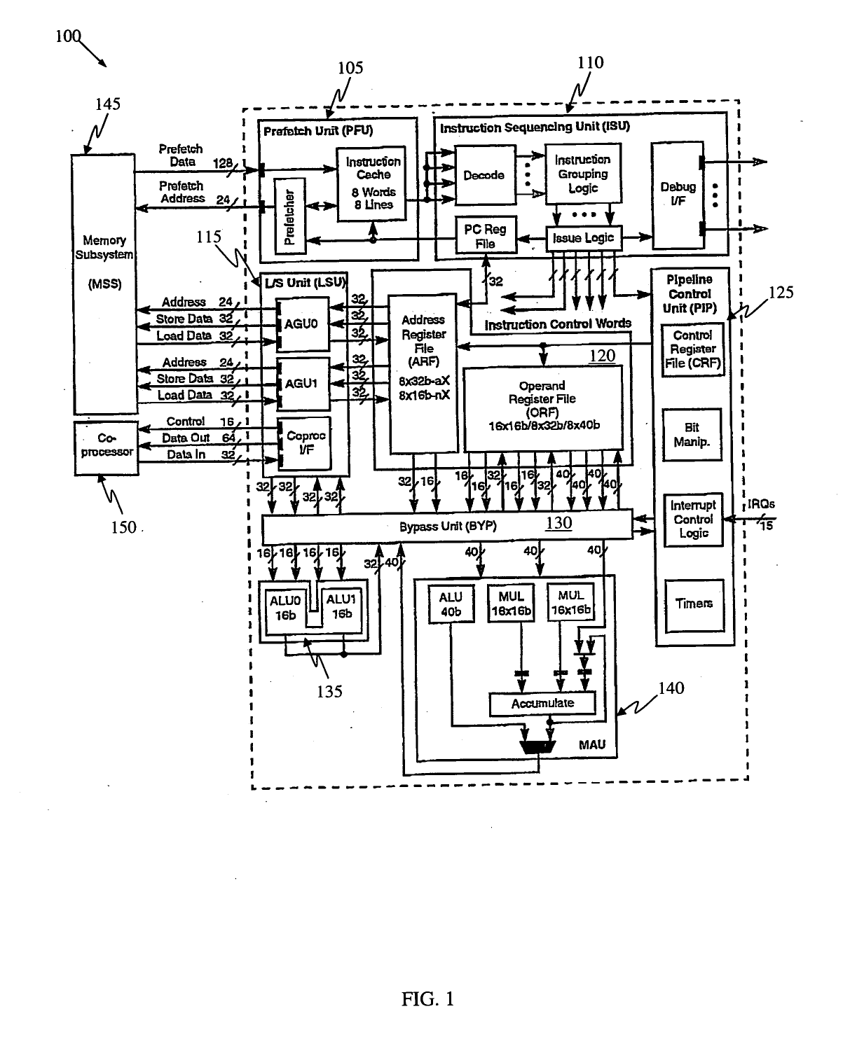

Referring initially to FIG. 1, illustrated is a block diagram of a processor 100 designed according to the principles of the present invention. In an exemplary embodiment, the processor 100 is a digital signal processor (DSP). An example of such a processor is a ZSP™500 DSP core, manufactured by LSI Logic, Incorporated, of Cupertino, California. However, the present invention is not limited to a particular class, type or manufacturer of processor.

The general architecture of DSPs is well known. The processor 100 comprises several major functional blocks, including a prefetch unit (PFU) 105, an instruction sequence unit (ISU) 110, a load/store unit (LSU) 115, an instruction control word (ICW) unit 120, a pipeline control unit (PIP) 125, a bypass (BYP) unit 130, an arithmetic logic unit (ALU) 135, and a multiply-accumulate unit (MAU) 140. Other embodiments of the processor 100 may have fewer, more, or different functional units, as required. In the illustrated embodiment, the processor 100 is also combined with a memory subsystem (MSS) 145 and a coprocessor 150.

The instructions are executed by the processor 100 in a pipelined fashion. Execution pipelines are well known in the art. The pipeline control unit (PIP) 125 provides the functionality to manage the orderly operation of the one or more pipelines that may be used in the processor 100.

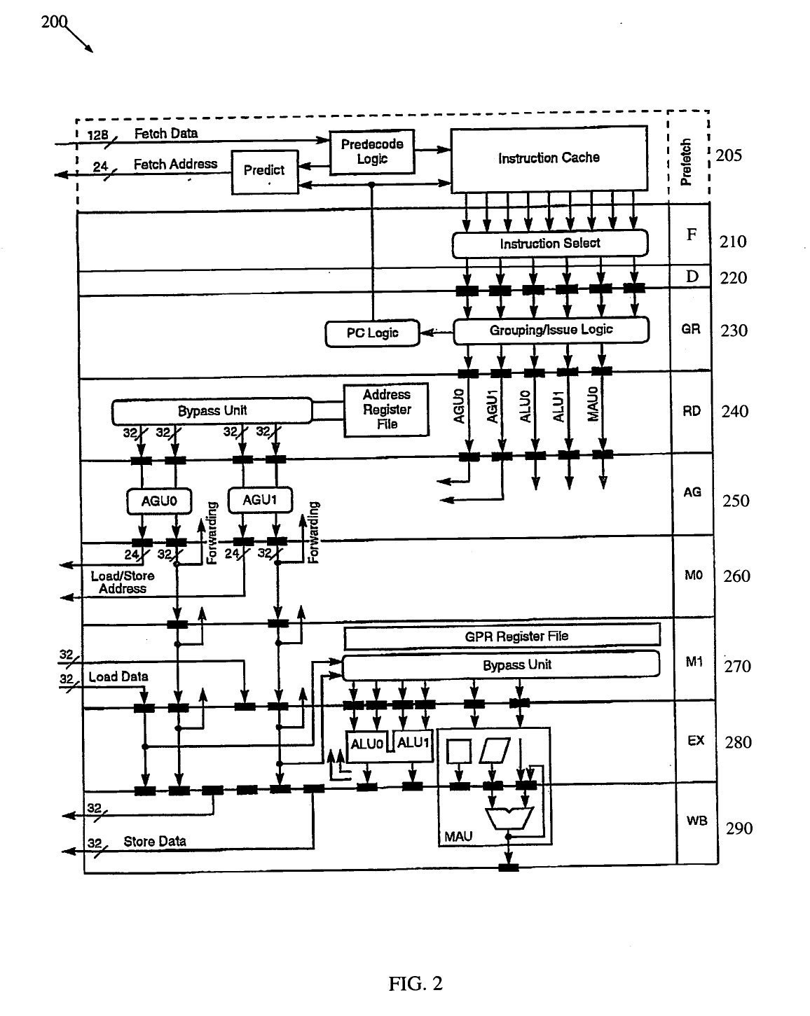

Turning to FIG. 2, shown is an exemplary pipeline 200 of the processor 100. The major functional units shown in FIG. 1 have been reordered in FIG. 2 in the order in which each is used in the pipeline. The illustrated pipeline comprises nine stages: a prefetch (PF) stage 205, a fetch (F) stage 210, a decode (D) stage 220, a group (GR) stage 230, a read data (RD) stage 240, an address generation (AG) stage 250, a first memory (M0) stage 260, a second memory (M1) stage 270, an execute (EX) stage 280 and a writeback (WB) stage 290. Those skilled in the pertinent art will appreciate that the number of pipeline stage is dependent on the overall design architecture of the processor, and that the present invention may be practiced with a number of stages different than the embodiment illustrated in FIG. 2.

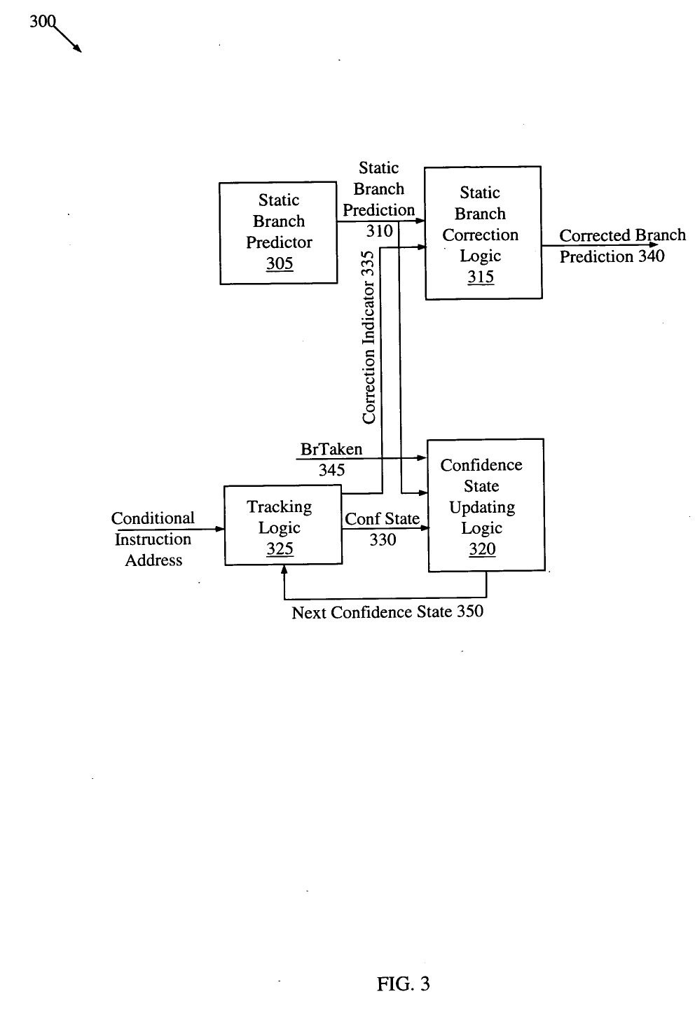

Turning now to FIG. 3, a branch predictor 300 constructed according to the principles of the present invention is illustrated. A static branch predictor 305 provides a static branch prediction 310 to static branch correction logic 315 and confidence state updating logic 320. The static branch prediction 310 may have a value of BRANCH (logical 1, e.g.), indicating that the next instruction to be executed is along the predicted branch, or NOBRANCH (logical 0, e.g.), indicating that the next sequential instruction is to be executed. The static branch prediction may be determined from a partially decoded instruction in the decode stage of the processor. The prediction is static in the sense that it is not updated based on a history of actual branches taken.

Tracking logic 325 receives an instruction address corresponding to a conditional instruction. In response to the conditional instruction address, the tracking logic 325 provides a confidence state 330 to the confidence state updating logic 320. The confidence state 330 is a measure of the historical accuracy of the static branch prediction at the conditional instruction address. The tracking logic 325 also provides a correction indicator 335 to the static branch correction logic 315. In response to the static branch prediction 310 and the correction indicator 335, the static branch correction logic 315 may override the static branch prediction 310 via a corrected branch prediction 340.

The confidence state updating logic 320, in addition to the previously described inputs, receives a branch taken signal, BrTaken 345. BrTaken 345 may be produced by pipeline control logic from comparison results (also known as condition codes) generated in the execution pipeline stage 280 of the processor. From these inputs, the confidence state updating logic 320 provides a next confidence state 350 to the tracking logic 325. In one embodiment of the present invention, the confidence state is a numeric value that is incremented when a branch prediction by the static branch predictor 305 is incorrect. Thus, higher values of the confidence state indicate less confidence in the static prediction. The confidence state is decremented when a branch prediction by the static branch predictor 305 is correct. Thus, lower values of the confidence state indicate greater confidence in the static prediction.

In one embodiment of the present invention, the confidence state is a two-bit value, and saturates at the highest confidence state 00 and the lowest confidence state 11. The tracking logic 325 stores the next confidence state 350 in a manner that allows retrieval of the state corresponding to the conditional instruction address when the program revisits that particular instruction address. Thus, a history is provided of past accuracy of the branch prediction for that instruction. By providing addressable storage, the tracking logic 325 may preserve the confidence state associated with multiple instructions.

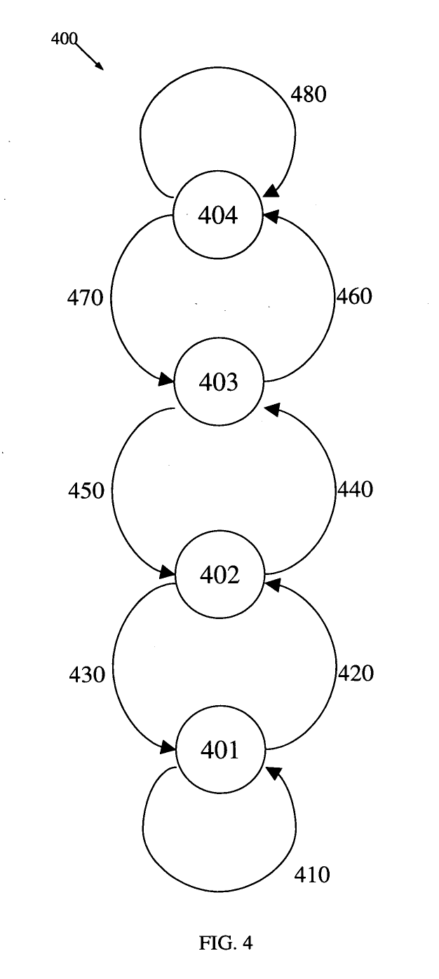

Turning now to FIG. 4, illustrated is a state diagram 400 of a branch predictor designed according the principles of the present invention. The state diagram includes four states: a first state 401, a second state 402, a third state 403 and a fourth state 404. As described previously, two bits may describe these four states. The first state 401 represents the highest state of confidence in a static branch prediction, and the fourth state 404 represents the lowest state of confidence.

Table 1 illustrates one embodiment of the manner that the state machine 400 may respond to the static branch prediction 310, the current confidence state 330, and the BrTaken 345. If the static branch prediction is NOBRANCH (0), but the branch is taken, or if the static branch prediction is BRANCH (1), but the branch is not taken, then the confidence in the static branch prediction is reduced. Accordingly, the state machine advances from a lower state to a higher state, e.g., the first state 401 to the second state 402 via a state transition 420. In a similar manner, the state machine 400 may advance to the third state 403 and the fourth state 404 via a state transition 440 or a state transition 460, respectively, if subsequent failures to predict the branch correctly occur. Once in the fourth state 404, additional failures result in the state machine 400 remaining in the fourth state 404 via a state transition 480.

If instead the static branch prediction is BRANCH, and the branch is taken, or if the static branch prediction is NOBRANCH, and the branch is not taken, then the confidence in the static branch prediction is increased. Accordingly, the state machine makes a transition from a higher state to a lower state, e.g., the fourth state 404 to the third state 403 via a state transition 470. In a similar manner, the state machine 400 may transition to the second state 402 and the first state 401 via a state transition 450 or a state transition 430, respectively, if there are subsequent successes in correctly predicting the branch. Once in the first state 401, additional agreement results in the state machine 400 remaining in the first state 401 via a state transition 410.

Those skilled in the art will appreciate that other truth tables representing alternate choices of state change logic are possible while remaining within the spirit of the present invention. Moreover, the number of states in the machine may be expanded as appropriate. //

Table 1

TABLE 1

| | | | | | Next | | |
|---|---|---|---|---|---|---|---|
| | | | Static | | Confi- | State | Corrected |
| | | | Branch | | dence | Tran- | Branch |
| State | MSB | LSB | Predict | BrTaken | State | sition | Predict |
| 401 | 0 | 0 | 0 | 0 | 00 | 410 | 0 |
| | | | 0 | 1 | 01 | 420 | 0 |
| | | | 1 | 0 | 01 | 420 | 1 |
| | | | 1 | 1 | 00 | 410 | 1 |
| 402 | 0 | 1 | 0 | 0 | 00 | 430 | 0 |
| | | | 0 | 1 | 10 | 440 | 0 |
| | | | 1 | 0 | 10 | 440 | 1 |
| | | | 1 | 1 | 00 | 430 | 1 |
| 403 | 1 | 0 | 0 | 0 | 01 | 450 | 1 |
| | | | 0 | 1 | 11 | 460 | 1 |
| | | | 1 | 0 | 11 | 460 | 0 |
| | | | 1 | 1 | 01 | 450 | 0 |
| 404 | 1 | 1 | 0 | 0 | 10 | 470 | 1 |
| | | | 0 | 1 | 11 | 480 | 1 |
| | | | 1 | 0 | 11 | 480 | 0 |
| | | | 1 | 1 | 10 | 470 | 0 |

In the illustrated embodiment, the use of four states to describe the spectrum of confidence in the static branch prediction advantageously stabilizes the corrected branch prediction 340 against loop-end conditions. For example, if the processor is executing a-loop, the static branch predictor may predict that the loop-end instruction will branch to the beginning of the loop. However, when the loop-end condition is satisfied, the next instruction may be the next sequential instruction after the loop-end instruction. This results in a conflict between the predicted address and the address taken, and the confidence state for loop-end instruction advances to a less confident state. If only one bit were used to represent the confidence state, an exit from the loop would cause the confidence state for the loop-end address to be “1,” indicating lack of confidence in the static branch prediction. When the loop is encountered again, a mispredict would be guaranteed for the first cycle of the loop, resulting in inefficient operation. On the other hand, if two bits are used, then on loop exit the state advances to “01,” assuming the confidence state was previously “00.” When the loop is encountered again, the loop-end instruction correctly predicts a branch to the beginning of the loop, thereby restoring the confidence state to “00,” and no mispredict occurs. Thus, a two-bit state machine provides a more efficient operation.

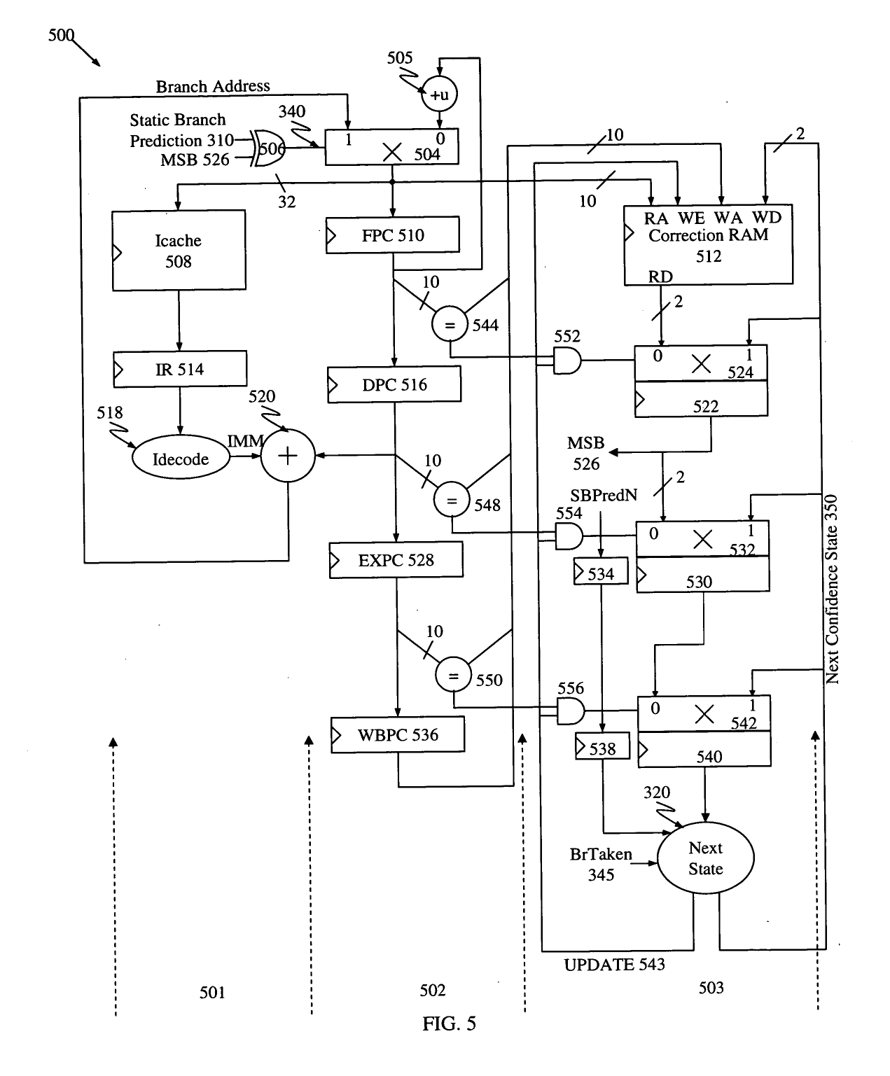

Turning now to FIG. 5, illustrated is a more specific embodiment 500 of branch predictor 300 designed according to the principles of the present invention. FIG. 5 shows three parallel pipelines: an instruction pipeline 501, an address pipeline 502 and a confidence state pipeline 503. The instruction pipeline 501, address pipeline 502 and confidence state pipeline 503 may be physically associated with the Prefetch Unit 105 or the Pipeline Control Unit 125, though those skilled in the pertinent art understand that this is only one of many options open to the designer.

In FIG. 5, in the interest of brevity, the GR, RD, AG, M0 and M1 pipeline stages have been omitted. It will be immediately apparent to those skilled in the pertinent art that the illustrated embodiment can be extended to an arbitrarily deep pipeline.

The operation of the instruction pipeline 501, address pipeline 502 and confidence state pipeline 503 is interrelated. Common to each pipeline is an address selector 504 that is operative in the prefetch stage 205 of the processor. The address selector 504 receives as inputs a branch address, the derivation of which is discussed below, and the next sequential address in the instruction sequence, represented by an address incrementer 505. The selection of the branch address or the next sequential address is effected by the output of an exclusive OR (XOR) gate 506, which is the corrected branch prediction 340. For the sake of discussion, it is assumed that the corrected branch prediction 340 predicts NOBRANCH, thereby selecting the next sequential address in the instruction sequence. This address is designated AddrN.

In a first clock cycle, AddrN enters the fetch stage 210 of the processor, and an Icache 508 and an FPC register 510 latch AddrN. The Icache 508 accordingly presents the instruction InstrN, corresponding to AddrN, at its output. Also in the first clock cycle, the AddrN is latched into a read address (RA) input of a correction state RAM 512. A current correction state CStateN corresponding to AddrN is read from the RAM 512 and appears at a read data (RD) output of the RAM 512. In the illustrated embodiment, the RAM 512 is a two-port RAM, allowing read and write in the same clock cycle. Those skilled in the pertinent art will appreciate that other embodiments of correction state storage are possible, including, but not limited to, use of a single-port RAM.

In a second clock cycle, InstrN, AddrN and CStateN enter the decode stage 220, where an instruction register 514 latches InstrN, and a DPC register 516 latches AddrN. An instruction decoder, Idecode, 518 derives an immediate relative address, ImmN, from InstrN. ImmN is an offset from the current program counter, representing the relative address of a branch address. ImmN is added by an adder 520 to AddrN held by the DPC 516 to compute a branch address, designated BrAddrN+1. BrAddrN+1 is provided as an input to the address selector 504.

Also during the second clock cycle, a register 522 latches the output of a multiplexer (MUX) 524 that selects between the CStateN and a CState corresponding to an earlier instruction address in the pipeline. The purpose of this selection will be described below, but in the current discussion, the MUX 524 is assumed to select the CStateN. Thus, the CStateN is latched into the register 522 in the second clock cycle.

The address selector 504 now has the next sequential address AddrN+1 and the predicted branch address BrAddrN+1 present at its inputs. One of these addresses is selected according to the state of the corrected branch prediction 340. In the illustrated embodiment, the corrected branch prediction 340 is the XOR of the static branch prediction 310, and a most significant bit (MSB) 526 of the CStateN latched by the register 522.

If the CStateN is either the first state 401 or the second state 402, described as a binary “00” or “01,” respectively, then the MSB of the CStateN is “0.” These states represent a higher confidence that the static branch prediction 310 correctly predicts a branch at AddrN. Alternatively, if CStateN is either the third state 403, or the fourth state 404, described as a binary “10” or “11” respectively, then the MSB of the CStateN is “1.” These states represent a lower confidence that the static branch prediction 310 correctly predicts a branch at AddrN. Thus, the MSB 526 of CStateN is a correction indicator associated with the conditional branch instruction InsrtN.

Assuming that the MSB 526 is “0,” representing a higher confidence state of the state machine 400, then the static branch prediction 310 passes through the XOR gate 506 unchanged, and the BrAddrN+1or AddrN+1 is selected as the static branch predictor 305 has predicted.

If the MSB 526 is “1,” however, representing a lower confidence state of the state machine 400, then the XOR gate 506 inverts the static branch prediction 310. As a result, the BrAddrN+1 or AddrN+1 is selected contrary to the prediction of the static branch predictor 305.

In a third clock cycle, the AddrN and CStateN are latched into an EXPC register 528 and a register 530, respectively. It is assumed for the moment that a MUX 532 selects the CStateN to be latched into the register 530. Also in this third clock cycle, the static branch prediction associated with instruction address N, SBPredN, is latched into a register 534 to remain aligned with the AddrN and CStateN.

In a fourth clock cycle, the AddrN, CStateN and SBPredN are latched into a WBPC register 536, a register 538 and a register 540, respectively. It is assumed that a MUX 542 selects the CStateN. The confidence state updating logic 320 receives the CStateN, SBPredN and BrTakenN (the BrTaken 345 signal associated with the instruction at address AddrN) signals as inputs to determine whether a change of confidence of the static prediction corresponding to AddrN is needed. The BrTakenN signal is provided by logic associated with the execute stage 280 of the pipeline that determines the outcome of the condition associated with the InstrN. In the illustrated embodiment, the next confidence state 350 is determined according to the truth table presented in Table 1.

The confidence state updating logic 320 presents the value of the computed next confidence state associated with the AddrN to the write data (WD) input of the RAM 512, and may simultaneously assert the write enable (WE) input of the RAM 512 with an UPDATE 543 signal. The address corresponding to the confidence state, AddrN, is presented by the WBPC register 536 to the write address (WA) inputs of the RAM 512. On the next clock cycle of the processor, the next confidence state 350 of the static branch prediction may be stored at AddrN in the RAM 512, thus providing a history of the confidence of the static branch prediction for future processor calls to InstrN. In one embodiment, the UPDATE 543 signal is asserted only when the update changes the confidence state.

Comparators 544, 548 and 550, in combination with AND gates 552, 554, 556 and the MUXes 524, 532, 542, provide a means to handle instruction loops that are shorter than the pipeline of the processor. These so-called “short loops” require special handling because by the time an earlier use of the branch instruction defining the loop reaches the writeback stage of the pipeline, a later use of the same instruction has entered the pipeline behind it. Without special handling, the updated confidence state resulting from the earlier use of the instruction may not be available to the confidence state updating logic 320 when the later use of the instruction reaches the writeback stage of the pipeline.

To accommodate this situation, the comparators 544, 548 and 550, the AND gates 552, 554, 556 and the MUXes 524, 532, 542 provide a feed-forward capability to the confidence state pipeline 503. For example, consider the case of an instruction loop of four instructions ending with a conditional branch instruction, and the four illustrated pipeline states in FIG. 5. When the loop is repeated, an earlier use of the branch instruction reaches the WB stage as a later use is entering the fetch stage 210. The address of the earlier use of the instruction is provided simultaneously to the comparator 544 by the WBPC register 536 and the FPC register 510. The comparator 544 then enables the AND gate 552, thus allowing the UPDATE 543 signal to select the next confidence state 350 corresponding to the earlier use of the instruction, via the MUX 524. Thus, the correct confidence state corresponding to the later use of the instruction remains aligned with the address of the instruction. Shorter short loops are accommodated by the feed-forward logic associated with later pipeline stages.

The width of the address field used to access the confidence state of a conditional branch instruction in the RAM 512 may be made smaller than the full address field width of the instruction address. In one embodiment, the address field input to the RAM 512 may be less than a less significant half of the instruction address. In FIG. 5, for example, the address of the conditional branch instruction is 32 bits wide, and the width of the address field input to the RAM 512 is 10 bits. This embodiment results in the aliasing of up to 2²² instructions onto each confidence state address in the RAM 512. While this embodiment results in some risk that the confidence state associated with one conditional branch may be overwritten by the confidence state associated with another conditional branch, the risk of resulting inefficiency of execution in the processor is reduced by good static prediction, which tends to keep confidence states weighted toward high confidence. Also, linear execution of program instructions tends to localize temporally the association of a particular conditional branch instruction with a confidence state address in the RAM 512. For at least these reasons, risks associated with a highly aliased design are outweighed by the resulting small size of the RAM 512 and the improved branch prediction resulting from the present invention.

Although the present invention has been described in detail, those skilled in the art should understand that they could make various changes, substitutions and alterations herein without departing from the spirit and scope of the present invention in its broadest form.

What is claimed is:

1. A branch predictor, comprising:
static branch correction logic configured to employ a static branch prediction and a correction indicator associated with a particular conditional branch in a computer program to generate a corrected branch prediction pertaining to said particular conditional branch; and
confidence state updating logic associated with said static branch correction logic and configured to employ said static branch prediction and a branch taken indicator associated with said particular conditional branch to update a confidence state associated with said particular conditional branch, said correction indicator based on said confidence state.

2. The branch predictor as recited in claim 1 wherein said confidence indicator is a most significant bit of said confidence state.

3. The branch predictor as recited in claim 1 wherein said confidence state is expressed in at least two bits.

4. The branch predictor as recited in claim 1 further comprising a memory associated with said confidence state updating logic and configured to contain said confidence state at an address that is only a portion of an address of said particular conditional branch.

5. The branch predictor as recited in claim 4 wherein said portion is less than a less significant half of said address of said particular conditional branch.

6. The branch predictor as recited in claim 1 further comprising registers associated with corresponding stages in a pipeline configured to shift said confidence state therethrough as said particular conditional branch travels through said corresponding stages.

7. The branch predictor as recited in claim 1 wherein said confidence state updating logic yields an updated confidence state, said confidence state updating logic causing said updated confidence state to be stored in a memory only if said update changes said confidence state.

8. A method of predicting a conditional branch, comprising:
employing a static branch prediction and a correction indicator associated with a particular conditional branch in a computer program to generate a corrected branch prediction pertaining to said particular conditional branch; and
employing said static branch prediction and a branch taken indicator associated with said particular conditional branch to update a confidence state associated with said particular conditional branch, said correction indicator based on said confidence state.

9. The method as recited in claim 8 wherein said confidence indicator is a most significant bit of said confidence state.

10. The method as recited in claim 8 wherein said confidence state is expressed in at least two bits.

11. The method as recited in claim 8 further comprising storing said confidence state in a memory at an address that is only a portion of an address of said particular conditional branch.

12. The method as recited in claim 11 wherein said portion is less than a less significant half of said address of said particular conditional branch.

13. The method as recited in claim 8 further comprising retrieving said confidence state from a memory and shifting said confidence state through registers associated with corresponding stages in a pipeline.

14. The method as recited in claim 8 wherein said employing said static branch prediction and said branch taken indicator to update said confidence state yields an updated confidence state, said method further comprising storing said updated confidence state in a memory only if said update changes said confidence state.

15. A digital signal processor, comprising:
a pipeline having stages and configured to execute a computer program containing conditional branches;
static branch correction logic configured to employ a static branch prediction and a correction indicator associated with a particular conditional branch in said computer program to generate a corrected branch prediction pertaining to said particular conditional branch;
confidence state updating logic associated with said static branch correction logic and configured to employ said static branch prediction and a branch taken indicator associated with said particular conditional branch to update a confidence state associated with said particular conditional branch, said correction indicator based on said confidence state; and
registers associated with corresponding ones of said stages configured to shift said confidence state therethrough as said particular conditional branch travels through said corresponding stages.

16. The digital signal processor as recited in claim 15 wherein said confidence indicator is a most significant bit of said confidence state.

17. The digital signal processor as recited in claim 15 wherein said confidence state is expressed in at least two bits.

18. The digital signal processor as recited in claim 15 further comprising a memory associated with said confidence state updating logic and configured to contain said confidence state at an address that is only a portion of an address of said particular conditional branch.

19. The digital signal processor as recited in claim 18 wherein said portion is less than a less significant half of said address of said particular conditional branch.

20. The digital signal processor as recited in claim 15 wherein said confidence state updating logic yields an updated confidence state, said confidence state updating logic causing said updated confidence state to be stored in a memory only if said update changes said confidence state.
